(19) United States
(12) Patent Application Publication
(10) Pub. No.: US 2005/0048302 A1
(43) Pub. Date: Mar. 3, 2005

(54) Releasing sheet and pressure-sensitive adhesive article

(75) Inventors: Isao Sakurai, Saitama (JP); Tomishi Shibano, Saitama (JP)

Correspondence Address: Brinks Hofer Gilson & Lione, P O Box 10395, Chicago, IL, 60610, US

(73) Assignee: LINTEC Corporation, Tokyo (JP)

(21) Appl. No.: 10/489,401

(22) PCT Filed: Sep. 10, 2002
(86) PCT No.: PCT/JP02/09220

(30) Foreign Application Priority Data
Sep. 10, 2001 (JP) 2001-274331

(51) Int. Cl. B32B 9/00; B32B 27/32; B32B 33/00

(52) U.S. Cl. 428/500; 428/40.1; 428/523

(57) ABSTRACT

Disclosed herein are a release sheet and a pressure sensitive adhesive sheet with release sheet. The release sheet and the pressure sensitive adhesive sheet with release sheet of the present invention are hard to give adverse effects to hard disk drives or the like, when a pressure sensitive adhesive sheet peeled off from the release sheet is attached to the hard disk drives or the like. The pressure sensitive adhesive sheet with release sheet has a structure in which a pressure sensitive adhesive sheet comprised from a pressure sensitive adhesive layer and a pressure sensitive adhesive sheet base is adhered to a release sheet comprised from a releasing agent layer and a release sheet base, wherein the pressure sensitive adhesive layer is in contact with the releasing agent layer. The release sheet includes a releasing agent layer comprised of an olefin-based thermoplastic elastomer and a polyolefin resin, and a release sheet base. The density of the olefin-based thermoplastic elastomer is less than 0.87 g/cm³. The weight ratio of the olefin-based thermoplastic elastomer to the polyolefin resin is preferably in the range of 15:85 to 85:15.

### BACKGROUND

1. Field of the Invention

This invention relates to a release sheet and a pressure sensitive adhesive sheet with release sheet.

2. Background Information

Hard disk drives are widely used as computer peripheral equipment. In these hard disk drives, pressure sensitive adhesive sheets are attached for various purposes such as temporary fixation of parts during the manufacturing process of the hard disk drives, indication of names and numbers of parts, closing of holes formed for inspection or the like in a main body or a cover. Such a pressure sensitive adhesive sheet is generally composed of a pressure sensitive adhesive sheet base and a pressure sensitive adhesive layer, and is being adhered to a release sheet until the pressure sensitive adhesive sheet is attached to a hard disk drive or the like.

On a surface of the release sheet (a surface to be attached to the pressure sensitive adhesive layer), a releasing agent layer is provided for improving releasability. Conventionally, a silicone resin has been used as a constituent material of the releasing agent layer.

However, it is known that when such a release sheet is attached to the pressure sensitive adhesive sheet, low molecular weight silicone compound such as silicone resin, siloxane, silicone oil or the like contained in the release sheet is transferred into the pressure sensitive adhesive layer of the pressure sensitive adhesive sheet. Further, the release sheet is wound up in a rolled form after the production thereof, and in this state, the back surface of the release sheet is in contact with the releasing agent layer thereof, so that the silicone compound contained in the releasing agent layer is transferred to the back surface of the release sheet. In this regard, it is also known that the silicone compound transferred to the back surface of the release sheet is again transferred to the surface of a pressure sensitive adhesive sheet when a pressure sensitive adhesive sheet with release sheet is wound up in a rolled form in manufacturing the pressure sensitive adhesive sheet with release sheet. For this reason, it is also known that, when the pressure sensitive adhesive sheet to which such a release sheet has been adhered is attached to a hard disk drive, the silicone compound which has been transferred to the pressure sensitive adhesive layer or the surface of the pressure sensitive adhesive sheet gradually gasifies, and then the gasified silicone compound deposits on a magnetic head, a disk surface or the like, thereby forming a fine resin layer.

In the meantime, in recent years, high performance and high density hard disk drives have been developed in a very short period of time, and it is believed that the tendency of seeking such high performance and high density will continue after this. If the tendency of such high performance and high density of hard disk drives continues further, there is the possibility that fine deposition of the silicone compound gives rise to adverse effects on reading and writing of data from and to a hard disk drive.

### SUMMARY OF THE INVENTION

It is an object of the present invention to provide a release sheet and a pressure sensitive adhesive sheet with release sheet which are hard to give adverse effects to hard disk drives or the like.

In order to achieve the object stated above, the present invention is directed to a release sheet comprising a base and a releasing agent layer provided on the base, wherein the releasing agent layer is comprised of an olefin-based thermoplastic elastomer having a density of less than 0.87 g/cm³, and a polyethylene resin.

This makes it possible to provide a release sheet which is hard to give adverse effects to hard disk drives or the like.

In the release sheet of the present invention, it is preferred that the releasing agent layer is provided on the base through an adhesion enhancing layer. This improves adhesion between the releasing agent layer and the base, and as a result, it becomes possible to effectively prevent delamination from occurring at the interface between the releasing agent layer and the base in peeling off the release sheet from a pressure sensitive adhesive sheet having a pressure sensitive adhesive layer, and it becomes also possible to effectively prevent a part of the releasing agent layer from remaining on the pressure sensitive adhesive layer after the release sheet has been peeled off.

In the present invention, it is preferred that the weight ratio of the olefin-based thermoplastic elastomer to the polyethylene resin is in the range of 15:85 to 85:15. This makes it possible for the releasing agent layer to have especially excellent releasability.

Furthermore, it is also preferred that the main ingredient of the olefin-based thermoplastic elastomer is ethylene-propylene copolymer or ethylenebutene copolymer. This makes it possible to obtain especially excellent releasability.

Moreover, it is also preferred that the thickness of the releasing agent layer is in the range of 5 to 50 μm. This makes it possible to obtain especially excellent releasability.

Moreover, it is also preferred that the base is constituted from a plastic film or lint-free paper. This makes it possible to prevent generation of particles or the like in processing or use, and therefore, electronic instruments such as hard disk drives or the like are hard to receive adverse effects.

Another aspect of the present invention is directed to a pressure sensitive adhesive sheet with release sheet comprising the release sheet described above, and a pressure sensitive adhesive sheet having a pressure sensitive adhesive layer. This makes it possible to provide a pressure sensitive adhesive sheet which is hard to give adverse effects to hard disk drives or the like.

In the pressure sensitive adhesive sheet with release sheet of the present invention, it is preferred that the pressure sensitive adhesive sheet has a base constituted from a plastic film or lint-free paper. This makes it possible to prevent generation of particles or the like in processing or use, and therefore, electronic instruments such as hard disk drives or the like are hard to receive adverse effects.

The above and further objects, structures, and effects of the present invention will be or become more apparent from the following description of the preferred embodiments.

### BRIEF DESCRIPTION OF THE DRAWINGS

FIG. 1 is a Table 1 which shows the kind of an olefin-based thermoplastic elastomer (TPO) which is a material of a releasing agent layer of a pressure sensitive adhesive sheet with release sheet, and the weight ratio of the olefin-based thermoplastic elastomer (TPO) to a polyethylene (PE) in the releasing agent layer, for each of the pressure sensitive adhesive sheets with release sheets produced in Examples and Comparative Example; and

FIG. 2 is a Table 2 which shows the results of various measurements for each of the pressure sensitive adhesive sheets with release sheets produced in Examples and Comparative Example.

### DETAILED DESCRIPTION OF THE PRESENTLY PREFERRED EMBODIMENTS

A detailed description will now be made with regard to a release sheet and a pressure sensitive adhesive sheet with release sheet of the present invention based on the preferred embodiments.

The pressure sensitive adhesive sheet with release sheet of the present invention has a structure in which a pressure sensitive adhesive sheet comprised from a pressure sensitive adhesive layer and a base (pressure sensitive adhesive sheet base) is adhered to a release sheet comprised from a releasing agent layer and a base (release sheet base), and wherein in such a pressure sensitive adhesive sheet with release sheet, the pressure sensitive adhesive layer is in contact with the releasing agent layer.

In such a pressure sensitive adhesive sheet with release sheet, the pressure sensitive adhesive sheet can be peeled off from the release sheet, and after peeling-off, the pressure sensitive adhesive sheet is attached to an adherend.

Hereinbelow, a description will be made with regard to the release sheet.

The release sheet has a structure in which a releasing agent layer is formed on a release sheet base.

The release sheet base has the function to support the releasing agent layer, and is constituted from, for example, a plastic film made of polyester film such as polyethylene terephthalate film or polybutylene terephthalate film, polyolefin film such as polypropylene film or polymethylpentene film, or polycarbonate film; metal foil made of aluminum or stainless steel or the like; and paper such as glassine paper, woodfree paper, coated paper, impregnated paper or synthetic paper.

Among these materials, it is particularly preferable that the release sheet base is constituted from a plastic film made of polyester film such as polyethylene terephthalate film or polybutylene terephthalate film, or polypropylene film; or so-called lint-free paper from which less particles are generated (e.g., JP-B-Heisei 06-11959). When the release sheet base is constituted from such a plastic film or lint-free paper, particles and the like are hard to generate in processing or use, and as a result, electronic instruments such as hard disk drives or the like are hard to receive adverse effects. Further, when the release sheet base is constituted from such a plastic film or lint-free paper, cutting, punching or the like during the processing becomes easy. In the case where a plastic film is used as the release sheet base, it is more preferable that such a plastic film is a polyethylene terephthalate film. The polyethylene terephthalate film has the advantages that generation of particles is low and generation of gas during heating is also low.

The thickness of the release sheet base is not limited to any specific value, but is preferably in the range of 10 to 200 μm, and more preferably in the range of 25 to 50 μm.

By providing the releasing agent layer on the release sheet base, it is possible to peel off the pressure sensitive adhesive sheet from the release sheet.

The releasing agent layer is constituted of a releasing agent containing at least an olefin-based thermoplastic elastomer and a polyethylene resin.

When the releasing agent layer is constituted of the olefin-based thermoplastic elastomer and the polyethylene resin, excellent releasability can be obtained so that the pressure sensitive adhesive sheet can be easily and reliably peeled off from the release sheet. Further, it becomes unnecessary for the releasing agent layer to contain any silicone compound therein, and therefore, in the pressure sensitive adhesive sheet with release sheet of the present invention, transfer of a silicone compound from the release sheet to the pressure sensitive adhesive layer does not occur. As a result, according to the pressure sensitive adhesive sheet with release sheet of the present invention, the phenomenon that a silicon compound is discharged from the pressure sensitive adhesive sheet after the pressure sensitive adhesive sheet has been attached to an adherend will not occur. Consequently, even in the case where the pressure sensitive adhesive sheet of the present invention is attached to adherends such as electronic instruments e.g., hard disk drives, the pressure sensitive adhesive sheet is hard to give adverse effects to such adherends.

The olefin-based thermoplastic elastomer may contain as its main ingredient ethylene-propylene copolymer, ethylenebutene copolymer or ethyleneoctene copolymer, or the like, for example. Among them, ethylene-propylene copolymer or ethylenebutene copolymer is preferable, and ethylene-propylene copolymer is more preferable.

By using an olefin-based thermoplastic elastomer containing ethylene-propylene copolymer as a main ingredient, a release sheet having especially excellent releasability can be obtained.

The olefin-based thermoplastic elastomer may contain polypropylene or polyethylene.

As for commercially available and preferable olefin-based thermoplastic elastomer, TAFMER series (products of Mitsui Chemicals, Inc.) can be mentioned, for example.

The density of the olefin-based thermoplastic elastomer is less than 0.87 g/cm³, and is preferably in the range of 0.20 to 0.869 g/cm³, more preferably in the range of 0.50 to 0.867 g/cm³, still more preferably in the range of 0.75 to 0.866 g/cm³, and most preferably in the range of 0.82 to 0.865 g/cm³.

If the density of the olefin-based thermoplastic elastomer exceeds the above upper limit value, sufficient releasability can not be obtained.

The density of the polyethylene resin is not limited to any specific value, but is preferably in the range of 0.890 to 0.925 g/cm³, and more preferably in the range of 0.900 to 0.922 g/cm³.

If the density of the polyethylene resin is less than the above lower limit value, there is a case that sufficient releasability can not be obtained. On the other hand, if the density of the polyethylene resin exceeds the above upper limit value, there is a case that sufficient releasability can not be obtained.

Preferably, such a polyethylene resin is synthesized using a transition metal catalyst such as Ziegler-Natta catalyst or metallocene catalyst.

In particular, a polyethylene resin which is synthesized using metallocene catalyst has excellent releasability and heat resistance.

Examples of the polyethylene resin produced using Ziegler-Natta catalyst include J-REX series (products of Japan Polyolefins Co., Ltd.), EXCELLEN series (products of Sumitomo Chemical Co., Ltd.), and HID□ series (products of Sumitomo Chemical Co., Ltd.). Examples of the polyethylene resin produced using metallocene catalyst include KERNEL series (products of Japan Polychem Corp.), SUMIKASEN E series (products of Sumitomo Chemical Co., Ltd.), EXCELLEN E series (products of Sumitomo Chemical Co., Ltd.), and EXCELLEN EX series (products of Sumitomo Chemical Co., Ltd.).

In this regard, it is to be noted that the releasing agent layer may contain two or more kinds of polyethylene resins having different compositions and/or densities, for example.

The weight ratio (mixing ratio) of the olefin-based thermoplastic elastomer to the polyethylene resin is not limited to any specific value, but is preferably in the range of 15:85 to 85:15, more preferably in the range of 25:75 to 75:25, and most preferably in the range of 25:75 to 60:40.

If the content of the olefin-based thermoplastic elastomer is too small, there is a case that sufficient releasability can not be obtained depending on the kinds of the olefin-based thermoplastic elastomer and the polyethylene resin.

On the other hand, if the content of the olefin-based thermoplastic elastomer is too large, there is a case that sufficient heat resistance can not be obtained depending on the kinds of the olefin-based thermoplastic elastomer and the polyethylene resin.

It is to be noted that the releasing agent layer may contain other resin components as well as various additives such as plasticizer or stabilizer. However, it is preferred that the releasing agent layer contains substantially no silicone.

The thickness of the releasing agent layer is not limited to any specific value, but is preferably in the range of 5 to 50 μm, and more preferably in the range of 15 to 30 μm. When the releasing agent layer has a thickness that lies within the above range, excellent releasability can be obtained.

Next, a description will be made with regard to the pressure sensitive adhesive sheet used in the present invention.

The pressure sensitive adhesive sheet has a structure in which a pressure sensitive adhesive layer is formed on a pressure sensitive adhesive sheet base.

The pressure sensitive adhesive sheet base has the function to support the pressure sensitive adhesive layer, and is constituted from, for example, a plastic film made of polyester such as polyethylene terephthalate or polybutylene terephthalate, polystyrene, or polypropylene; metal foil made of aluminum or stainless steel; paper such as lint-free paper or synthetic paper; and a laminate body of two or more of those materials.

Among these materials, it is particularly preferable that the pressure sensitive adhesive sheet base is constituted from a plastic film made of polyester such as polyethylene terephthalate or polybutylene terephthalate, or polypropylene; or lint-free paper. When the pressure sensitive adhesive sheet base is constituted from such a plastic film or lint-free paper, particles and the like are hard to generate in processing or use, and as a result, electronic instruments such as hard disk drives or the like are hard to receive adverse effects. In addition, cutting, punching, or the like during the processing becomes easy. Further, in the case where a plastic film is used as the pressure sensitive adhesive sheet base, it is more preferable that such a plastic film is a polyethylene terephthalate film. The polyethylene terephthalate film has the advantages that generation of particles is low, and generation of gas during heating is also low.

The thickness of the pressure sensitive adhesive sheet base is not limited to any specific value, but is preferably in the range of 10 to 200 μm, and more preferably in the range of 25 to 100 μm.

Printing or typing may be applied to the surface of the pressure sensitive adhesive sheet base (surface opposite to the surface on which the pressure sensitive adhesive layer is laminated). Further, surface treatment may be made to the surface of the pressure sensitive adhesive sheet base for the purpose of, for example, improving adhesion of printing or typing. Further, the pressure sensitive adhesive sheet may be used as a label.

The pressure sensitive adhesive layer is constituted of a pressure sensitive adhesive composition containing a pressure sensitive adhesive as a main ingredient.

Examples of the pressure sensitive adhesive include acrylic adhesives, polyester-based adhesives, and urethane-based adhesives. Among these adhesives, acrylic adhesives are particularly preferable as a pressure sensitive adhesive.

In the case where the releasing agent layer is composed of the olefin-based thermoplastic elastomer and the polyethylene resin as is the case with the present invention, the releasability of the pressure sensitive adhesive sheet becomes extremely good by using an acrylic adhesive as a pressure sensitive adhesive.

For example, in the case where the pressure sensitive adhesive layer is formed of an acrylic adhesive, such an adhesive can be constituted of a polymer or copolymer mainly containing a main monomer component for imparting adhesiveness, a comonomer component for imparting adhesiveness or cohesive force, and a functional group-containing monomer component for improving cross-linking site or adhesiveness.

Examples of the main monomer component include: acrylic acid alkyl esters such as ethyl acrylate, butyl acrylate, amyl acrylate, 2-ethylhexyl acrylate, octyl acrylate, cyclohexyl acrylate, benzyl acrylate or methoxyethyl acrylate; and methacrylic acid alkyl esters such as butyl methacrylate, 2-ethylhexyl methacrylate, cyclohexyl methacrylate or benzyl methacrylate.

Examples of the comonomer component include methyl acrylate, methyl methacrylate, ethyl methacrylate, vinyl acetate, styrene, and acrylonitrile.

Examples of the functional group-containing monomer component include carboxyl-containing monomers such as acrylic acid, methacrylic acid, maleic acid or itaconic acid; hydroxyl-containing monomers such as 2-hydroxyethyl (meth)acrylate, 2-hydroxypropyl (meth)acrylate or N-methylol acrylamide; acrylamide; methacrylamide; and glycidylmethacrylate.

By containing the respective components, adhesive strength and cohesive force of the pressure sensitive adhesive composition are improved. Further, because such acrylic resins generally do not have unsaturated bonding in the molecule, improvements of stability to light or oxygen can be attained. Furthermore, by appropriately selecting kind of monomer or molecular weight thereof, it is possible to obtain a pressure sensitive adhesive composition having qualities and properties according to its use.

The pressure sensitive adhesive composition may be either of a crosslinked type which needs cross-linking treatment, or a non-crosslinked type which does not need cross-linking treatment. Among them, the crosslinked type is more preferable. When the crosslinked type is used, a pressure sensitive adhesive layer having further excellent cohesive force can be formed.

Examples of a crosslinking agent that can be used for the crossliked type pressure sensitive adhesive composition include epoxy compounds, isocyanate compounds, metal chelate compounds, metal alkoxides, metal salts, amine compounds, hydrazine compounds, and aldehyde compounds.

If necessary, the pressure sensitive adhesive composition used in the present invention may contain various additives such as plasticizers, tackifiers or stabilizers.

The thickness of the pressure sensitive adhesive layer is not limited to any specific value, but is preferably in the range of 1 to 70 μm, and more preferably in the range of 10 to 40 μm.

The release sheet described above can be produced by preparing a release sheet base and then applying a releasing agent onto the release sheet base to form a releasing agent layer.

As for a method for applying the releasing agent onto the release sheet base, an extrusion laminating method is preferably used, for example.

The pressure sensitive adhesive sheet described above can be produced by preparing a pressure sensitive adhesive sheet base, and then applying a pressure sensitive adhesive composition onto the pressure sensitive adhesive sheet base to form a pressure sensitive adhesive layer.

As for a method for applying the pressure sensitive adhesive composition onto the pressure sensitive adhesive sheet base, a known method such as knife coating, roll coating, die coating or the like can be employed.

The pressure sensitive adhesive composition used in these methods may be a solvent type, an emulsion type, a hot melt type or the like.

Thereafter, the release sheet is superposed on the pressure sensitive adhesive sheet such that the pressure sensitive adhesive layer contacts the releasing agent layer, so that a pressure sensitive adhesive sheet with release sheet can be obtained.

According to these production methods, a pressure sensitive adhesive sheet with release sheet can be produced without exposing the release sheet to high temperature in the course of the production. Further, the release sheet is hard to receive influence of a solvent which is used in forming the pressure sensitive adhesive layer, for example.

The pressure sensitive adhesive sheet with release sheet may be produced by forming a pressure sensitive adhesive layer on the releasing agent layer of the release sheet, and then superposing a pressure sensitive adhesive sheet base onto the pressure sensitive adhesive layer.

Next, a description will be made with regard to a second embodiment of the pressure sensitive adhesive sheet with release sheet of the present invention.

It should be noted that the pressure sensitive adhesive sheet with release sheet of the second embodiment will be explained by focusing the difference between the first and second embodiments, and explanation for the overlapping points is omitted.

In the second embodiment, the release sheet has a structure in which the releasing agent layer is provided on the release sheet base through an adhesion enhancing layer as an intermediate layer.

According to such a structure, adhesion between the releasing agent layer and the release sheet base is improved. As a result, it is possible to prevent delamination from occurring at the interface between the releasing agent layer and the release sheet base in peeling off the release sheet from the pressure sensitive adhesive sheet. Further, it is also possible to prevent a part of the releasing agent layer from remaining on the pressure sensitive adhesive layer after the release sheet has been peeled off.

Examples of a material constituting the adhesion enhancing layer include polyethylene, modified polyethylenes, and other adhesive polyolefins.

The thickness of the adhesion enhancing layer is not limited to any specific value, but is preferably in the range of 5 to 50 μm, and more preferably in the range of 15 to 30 μm.

The release sheet can be produced by preparing a release sheet base, applying a constituent material of the adhesion enhancing layer onto the release sheet base to form an adhesion enhancing layer, and then applying a releasing agent onto the adhesion enhancing layer to form a releasing agent layer.

As for a method for applying a constituent material of the adhesion enhancing layer onto the release sheet base, an extrusion laminating method can be mentioned, for example.

In this embodiment, the intermediate layer is the adhesion enhancing layer that increases adhesive strength between the releasing agent layer and the release sheet base, but the intermediate layer may have purposes other than this. For example, the intermediate layer may be a barrier layer that prevents transfer of the components between the releasing agent layer and the release sheet base. Further, the release sheet may have two or more intermediate layers.

It should be noted that although the release sheet and the pressure sensitive adhesive sheet with release sheet of the present invention have been described based on the embodiments, the present invention is not limited to these embodiments. The pressure sensitive adhesive sheet with release sheet may have a structure in which two pressure sensitive adhesive layers are formed on both sides of the pressure sensitive adhesive sheet base, and release sheets are respectively attached to each of the pressure sensitive adhesive layers.

### EXAMPLE

Hereinbelow, a description will be made with regard to actual examples of the pressure sensitive adhesive sheet with release sheet of the present invention.

1. Production of pressure sensitive adhesive sheet with release sheet A release sheet was prepared by forming an adhesion enhancing layer onto one surface of a release sheet base by the extrusion laminating method, and then forming a releasing agent layer onto the adhesion enhancing layer by the extrusion laminating method. Then, a pressure sensitive adhesive sheet was prepared by forming a pressure sensitive adhesive layer onto one surface of a pressure sensitive adhesive sheet base by the knife coating method. Thereafter, by superposing the release sheet on the pressure sensitive adhesive sheet, a pressure sensitive adhesive sheet with release sheet was produced. The structure of each layer was as follows.

### Example 1

(1) Release Sheet Base

Structural material: Lint-free paper (“CLEAN PAPER” which is a product of LINTEC Corporation)
Thickness: 60 μm

(2) Releasing Agent Layer
Constituent material: A mixture of 50 parts by weight of olefin-based thermoplastic elastomer (“TAFMER P-0275” (ethylene-propylene copolymer) which is a product of Mitsui Chemicals Inc. and its density is 0.86 g/cm³), and 50 parts by weight of polyethylene resin (“J-REX JH807A” (linear low density polyethylene) which is a product of Japan Polyolefins Co., Ltd. and its density is 0.916 g/cm³)

(Note that the polyethylene was synthesized using Ziegler-Natta catalyst.)
Thickness: 15 μm

(3) Adhesion Enhancing Layer
Constituent material: Polyethylene (“L-405H” (low density polyethylene) which is a product of Sumitomo Chemical Co., Ltd. and its density is 0.924 g/cm³)
Thickness: 15 μm

(4) Pressure Sensitive Adhesive Layer
Constituent material: Acrylic adhesive (“PL shin” which is a product of LINTEC Corporation)
Thickness: 25 μm

(5) Pressure Sensitive Adhesive Sheet Base
Structural material: Polyethylene terephthalate film
Thickness: 50 μm

### Example 2

A pressure sensitive adhesive sheet with release sheet of Example 2 was produced in the same manner as Example 1 except that the releasing agent layer was produced from 25 parts by weight of olefin-based thermoplastic elastomer and 75 parts by weight of polyethylene.

### Example 3

A pressure sensitive adhesive sheet with release sheet of Example 3 was produced in the same manner as Example 1 except that the olefin-based thermoplastic elastomer in the releasing agent layer was changed to “TAFMER A-TX612” (ethylenebutene copolymer) (which is a product of Mitsui Chemicals Inc. and its density is 0.86 g/cm³).

### Example 4

A pressure sensitive adhesive sheet with release sheet of Example 4 was produced in the same manner as Example 3 except that the releasing agent layer was produced from 25 parts by weight of olefin-based thermoplastic elastomer and 75 parts by weight of polyethylene.

### Comparative Example

A pressure sensitive adhesive sheet with release sheet of Comparative Example was produced in the same manner as Example 1 except that the olefin-based thermoplastic elastomer in the releasing agent layer was changed to “TAFMER P0280G” (ethylene-propylene copolymer) (which is a product of Mitsui Chemicals Inc. and its density is 0.87 g/cm³).

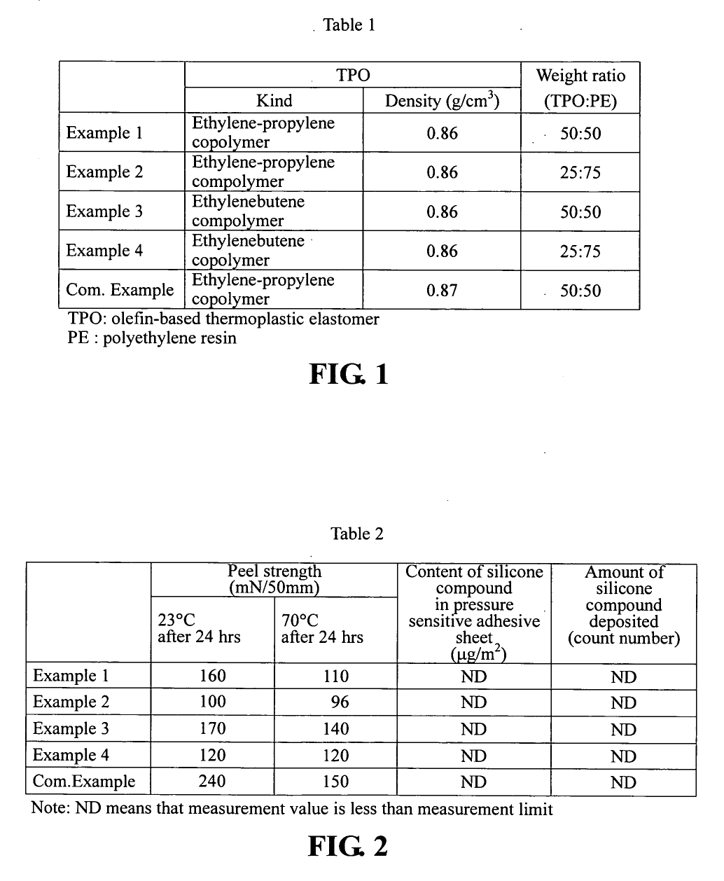

For each of the pressure sensitive adhesive sheets with release sheets of Examples and Comparative Example, the kind of olefin-based thermoplastic elastomer (TPO) which is a constituent material of the releasing agent layer, the density thereof, and the weight ratio of the olefin-based thermoplastic elastomer (TPO) to the polyethylene (PE) are shown in Table 1 in FIG. 1.

2. Evaluation

A load of 100 g/cm² was applied to each of the pressure sensitive adhesive sheets with release sheets produced in Examples and Comparative Example, at room temperature (23° C.) for 24 hours or at 70° C. for 24 hours. Then, after being left at room temperature for 24 hours, each pressure sensitive adhesive sheet with release sheet was cut so as to have a width of 50 mm, and then peel strength of the release sheet was measured using a tensile tester. Measurement of the peel strength was made by fixing the release sheet to a tensile tester and then pulling the pressure sensitive adhesive sheet base at a rate of 300 mm/min in 180° direction. Measurement results are shown in Table 2 in FIG. 2.

Further, for each of the pressure sensitive adhesive sheets with release sheets of Examples and Comparative Example, an amount of silicone compound contained in the pressure sensitive adhesive sheet was measured.

Each of the pressure sensitive adhesive sheets with release sheets was being left under the environment of an average temperature of about 23° C. and an average humidity of 65% RH for 30 days from the production thereof. After 30 days have passed, each pressure sensitive adhesive sheet with release sheet was cut into a square of 10 cm×10 cm. Then, the pressure sensitive adhesive sheet was peeled off from the release sheet. Using 10 ml of n-hexane at 23° C., the pressure sensitive adhesive sheet was subjected to extraction for 30 seconds. A resultant solution obtained was put into an agate mortar and the n-hexane was then evaporated, to thereby obtain an extract. A tablet was prepared using the obtained extract and 0.05 g of potassium bromide, and an amount of silicone compound contained in the tablet was measured with a beam condenser type FT-IR (a product of Perkin-Elmer Co.; trade name “PARAGON 1000”). The content of silicone compound per unit area of the pressure sensitive adhesive sheet was determined on the basis of the measurement result obtained, by use of an analytical curve (measurement limit: 50 μg/m²). The measurement results are shown in Table 2 in FIG. 2.

Furthermore, an amount of silicone compound deposited on a disk surface was measured. A method for measuring an amount of deposited silicone compound was as follows. Using each of the pressure sensitive adhesive sheets with release sheets produced in Examples and Comparative Example, an amount of silicone compound deposited on a disk surface was measured in the following manner.

The release sheet of the pressure sensitive adhesive sheet with release sheet just after production was peeled off, and then the pressure sensitive adhesive sheet was folded so that the pressure sensitive adhesive layer surfaces thereof were adhered to each other. Then, this was cut into a rectangle of 2 cm×1 cm. 200 samples of the thus obtained pressure sensitive adhesive sheet were placed in a stainless steel-made box having an inner size of 20 cm×11 cm×10 cm. A 3.5 inch hard disk drive from which its top plate cover had been removed was also placed in the box. Then, the box was closed with a lid, and in this state the hard disk drive was being left under the condition of 60° C. and 25% RH for 30 days while the hard disk drive was being operated.

Then, the hard disk drive was taken out of the box, and an amount of silicone compound deposited on the surface of the magnetic head was measured as a count number of silicon per minute by use of a wavelength dispersion type x-ray analyzer (“WDX-400” which is a product of Oxford Instruments Co.) (measurement limit: 200 counts; in the case of less than 200 counts, the presence or absence of silicone compound can not be determined due to influence of noise). The measurement results are shown in Table 2 in FIG. 2.

As is apparent from Table 2, each of the release sheets of the pressure sensitive adhesive sheets with release sheets obtained in Examples 1 to 4 exhibited small peel strength. This means that each of the pressure sensitive adhesive sheets with release sheets obtained in Examples 1 to 4 has excellent releasability. Further, it is confirmed that in the case where each of the pressure sensitive adhesive sheets with release sheets obtained in Examples and Comparative Example was being stored at room temperature, the peel strength of each of the release sheets of Examples was particularly smaller than that of Comparative Example.

Further, in each of the pressure sensitive adhesive sheets with release sheets obtained in Examples, the content of silicone compound was less than measurement limit (50 μg/m²).

Furthermore, in the case of each of the pressure sensitive adhesive sheets obtained in Examples, deposition of silicone compound was not confirmed on a surface of the hard disk drive.

On the other hand, the peel strength of the release sheet obtained in Comparative Example was large, and therefore, the pressure sensitive adhesive sheet with release sheet of Comparative Example had poor releasability.

Industrial Applicability

As has been described above, according to the present invention, it is possible to obtain a release sheet and a pressure sensitive adhesive sheet with release sheet which contain almost no or extremely small amount of silicone compound and have excellent releasability.

In the case where the release sheet or the pressure sensitive adhesive sheet with release sheet of the present invention is used, it is possible to prevent adverse effects due to silicone compound on reading and writing of data from and to a hard disk drive.

Further, since the release sheet and the pressure sensitive adhesive sheet with release sheet of the present invention have excellent releasability, the release sheet can be easily and reliably peeled off.

1. A release sheet, comprising a base and a releasing agent layer provided on the base, wherein the releasing agent layer is comprised of an olefin-based thermoplastic elastomer having a density of less than 0.87 g/cm³ and a polyethylene resin.

2. The release sheet as claimed in claim 1, wherein the releasing agent layer is provided on the base through an adhesion enhancing layer.

3. The release sheet as claimed in claim 1, wherein the weight ratio of the olefin-based thermoplastic elastomer to the polyethylene resin is in the range of 15:85 to 85:15.

4. The release sheet as claimed in claim 1, wherein the main ingredient of the olefin-based thermoplastic elastomer is ethylene-propylene copolymer or ethylenebutene copolymer.

5. The release sheet as claimed in claim 1, wherein the thickness of the releasing agent layer is in the range of 5 to 50 μm.

6. The release sheet as claimed in claim 1, wherein the base is constituted from a plastic film or lint-free paper.

7. A pressure sensitive adhesive sheet with release sheet, comprising the release sheet claimed in claim 1, and a pressure sensitive adhesive sheet having a pressure sensitive adhesive layer.

8. The pressure sensitive adhesive sheet with release sheet as claimed in claim 7, wherein the pressure sensitive adhesive sheet has a base constituted from a plastic film or lint-free paper.
